(19) United States
(12) Patent Application Publication
(10) Pub. No.: US 2009/0153070 A1
(43) Pub. Date: Jun. 18, 2009

(54) High-Pressure Discharge Lamp with an Improved Starting Capability, as Well as a high-voltage pulse generator

(76) Inventor: Andreas Kloss, Neubiberg (DE)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/227,670

(22) PCT Filed: Jun. 4, 2007
(86) PCT No.: PCT/EP2007/055464

§ 371 Date: Nov. 24, 2008

(30) Foreign Application Priority Data
Jun. 8, 2006 (DE) 10 2006 026 749.4

(51) Int. Cl. H01J 61/54; H05B 41/02

(52) U.S. Cl. 315/289; 313/323

(57) ABSTRACT

A spiral pulse generator is used to start a high-pressure discharge lamp and is accommodated directly in the external bulb of the lamp. The spiral pulse generator comprises two parts which are manufactured jointly as an LTCC component.

### TECHNICAL FIELD

The invention is based on a high-pressure discharge lamp according to the preamble of claim 1. Such lamps are in particular high-pressure discharge lamps for general lighting or for photo-optical purposes. The invention also relates to a high-voltage pulse generator, which can be used in particular for a lamp.

### PRIOR ART

The problem of starting high-pressure discharge lamps is solved at present by the starting device being integrated in the ballast. One disadvantage of this is that the supply lines have to be designed to withstand high voltages.

In the past, repeated attempts have been made to integrate the starting unit in the lamp. This has included trying to integrate it in the base. Particularly effective starting with the, prospect of high pulses is achieved by means of so-called spiral pulse generators, see U.S. Pat. No. 3,289,015. Some time ago, such devices were proposed for various high-pressure discharge lamps such as metal-halide lamps or sodium high-pressure lamps, see for example U.S. Pat. No. 4,325,004, U.S. Pat. No. 4,353,012. However, they were unable to establish themselves, for one reason because they are too expensive. Another reason is that the advantage of fitting them in the base is insufficient, since the problem of feeding the high voltage into the bulb remains. Therefore, the probability of detrimental effects to the lamp, whether insulating problems or a rupture in the base, increases greatly. Previously customary starting devices generally could not be heated above 100° C. The voltage generated then had to be fed to the lamp, which requires lines and lampholders with corresponding resistance to high voltages, typically about 5 kv.

For generating particularly high voltages, a double generator is used, see U.S. Pat. No. 4,608,521.

### SUMMARY OF THE INVENTION

The object of the present invention is to provide a high-pressure discharge lamp with significantly improved starting in comparison with previous lamps and no risk of detrimental effects being caused by the high voltage. This applies in particular to metal-halide lamps, where the material of the discharge vessel may be either quartz glass or ceramic.

This object is achieved by the characterizing features of claim 1.

Particularly advantageous configurations can be found in the dependent claims.

It is also an object of the present invention to provide a compact high-voltage pulse generator. A further object is to provide a high-voltage pulse generator which is compact and can generate high voltages above 15 kV. This object is achieved by the characterizing features of claim 14.

According to the invention, a high-voltage pulse with at least 15 kV, which can be used for starting a lamp for example, is now generated by means of a special temperature-resistant spiral pulse generator, which is integrated in the outer bulb in the immediate vicinity of the discharge vessel. Not only cold starting but also hot restarting is therefore possible.

The spiral pulse generator now used is, in particular, a so-called LTCC component. This material is a special ceramic, which can be made temperature-resistant up to 600° C. Although LTCC has already been used in connection with lamps, see US 2003/0001519 and U.S. Pat. No. 6,853,151, it has been used for entirely different purposes in lamps which are scarcely subjected to temperature loading at all, with typical temperatures below 100° C. The particular value of the high temperature stability of LTCC in connection with the starting of high pressure discharge lamps, such as primarily metal-halide lamps with starting problems, should be recognized.

The spiral pulse generator in its basic configuration is a component which combines the properties of a capacitor with those of a waveguide for generating starting pulses with a voltage of at least 1.5 kV. For production, two ceramic “green sheets” are printed with a metallic conductive paste and then wound in an offset fashion to form a spiral and finally pressed isostatically to form a molding. The subsequent co-sintering of the metal paste and ceramic sheet takes place in air in the temperature range of between 800 and 900° C. This processing allows for a range of use of the spiral pulse generator with temperature loading of up to 700° C. As a result, the spiral pulse generator can be accommodated in the outer bulb in the direct vicinity of the discharge vessel, but also in the base or in the immediate vicinity of the lamp.

Independently of this, such a spiral pulse generator may also be used for other applications, because it is not only stable at high temperature but also extremely compact. For this, it is essential that the spiral pulse generator is configured as an LTCC component, comprising ceramic sheets and metallic conductive paste. To supply adequate initial voltage, the spiral must comprise at least 5 turns.

In addition, this high-voltage pulse generator can be used as a basis for providing a starting unit that also comprises a charging resistor and a switch. The switch may be a spark gap or else a diac based on SiC technology.

In the case of an application for lamps, accommodation in the outer bulb is preferred. This is so because it dispenses with the need for a voltage supply line that is resistant to high voltages.

In addition, a spiral pulse generator can be dimensioned such that the high-voltage pulse even permits hot restarting of the lamp. The ceramic dielectric is distinguished by an extremely high dielectric constant ε of ε>10, with it being possible for an E of typically 70 to be achieved, up to ε=100, depending on material and construction. This provides a very high capacity of the spiral pulse generator and permits a comparatively great temporal width of the pulses generated. As a result, a very compact construction of the spiral pulse generator is possible, with the result that it can be integrated in commercially available outer bulbs of high-pressure discharge lamps.

The great pulse width also facilitates the flashover in the discharge volume.

Any customary glass can be used as the material of the outer bulb, that is in particular hard glass, Vycor or quartz glass. The choice of the filling is also not subject to any particular restriction.

### BRIEF DESCRIPTION OF THE DRAWINGS

The invention will be explained in more detail below on the basis of several exemplary embodiments. In the figures:

FIG. 1 shows the basic construction of a spiral pulse generator;

FIG. 2 shows characteristics of an LTCC spiral pulse generator;

FIG. 3 shows the basic construction of a sodium high-pressure lamp with, a spiral pulse generator in the outer bulb;

FIG. 4 shows the basic construction of a metal-halide lamp with a spiral pulse generator in the outer bulb;

FIB. 5 shows a metal-halide lamp with a spiral pulse generator in the outer bulb;

FIG. 6 shows a metal-halide lamp with a spiral pulse generator in the base;

FIG. 7 shows characteristics of an LTCC spiral pulse generator, a normal embodiment (FIG. 7a) being compared with a compact double embodiment (FIG. 7b);

FIG. 8 shows the wiring principle for a double spiral pulse generator;

FIG. 9 shows the construction of a double LTCC spiral pulse generator in detail.

### PREFERRED EMBODIMENT OF THE INVENTION

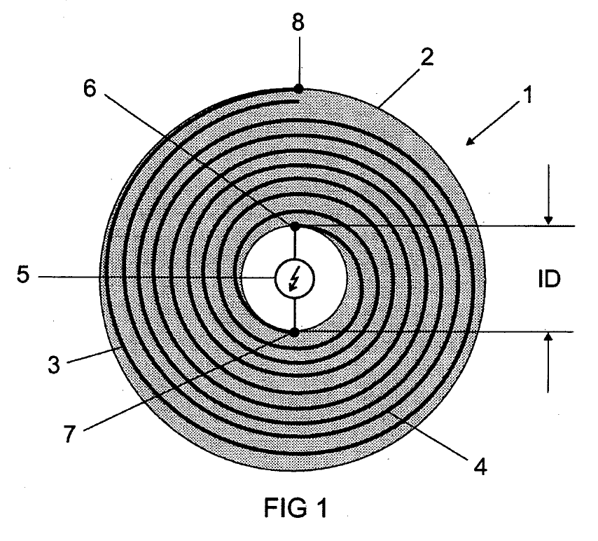

FIG. 1 shows the construction of a spiral pulse generator 1 in plan view. It comprises a ceramic cylinder 2, in which two different metallic conductors 3 and 4 are spirally wound as a strip. The cylinder 2 is hollow on the inside and has a given inner diameter ID. The two inner contacts 6 and 7 of the two conductors 3 and 4 are approximately opposite one another and are connected to one another by a spark gap 5.

Only the outer one of the two conductors has a further contact 8 on the outer periphery of the cylinder. The other conductor ends open. As a result, the two conductors together form a waveguide in a dielectric medium, the ceramic.

The spiral pulse generator is either wound from two ceramic sheets coated with metal paste or constructed from two metal foils and two ceramic sheets. An important characteristic in this case is the number n of turns, which should preferably be of the order of magnitude of 5 to 100. This coil arrangement is then laminated and subsequently sintered, which produces an LTCC component. The spiral pulse generators created in this way with a capacitor property are then connected to a spark gap and a charging resistor.

The spark gap may be located at the inner or outer terminals or else within the winding of the generator. A spark gap which is based on SiC and is thermally very stable may be used with preference as the high-voltage switch, which initiates the pulse. For example, the switching element MESFET from the Cree company may be used. This is suitable for temperatures above 350° C.

In an actual exemplary embodiment, a ceramic material with ε=60 to 70 is used. The dielectric used here is preferably a ceramic sheet, in particular a ceramic strip such as Heratape CT 707 or preferably CT 765, each from Heraeus, or else a mixture of the two. The thickness of the green sheet is typically 50 to 150 μm. The conductor used is, in particular, Ag conductive paste such as “Cofirable Silver”, likewise from Heraeus. An actual example is CT 700 from Heraeus. Good results are also achieved with the metal paste 6142 from DuPont. These parts can be laminated well and then burnt out (“burnout”) and sintered together “co-firing”.

The inner diameter ID of the spiral pulse generator is 10 mm. The width of the individual strips is likewise 10 mm. The sheet thickness is 50 μm and the thickness of the two conductors is also in each case 50 μm. The charging voltage is 300 V. Under these conditions, the spiral pulse generator achieves an optimum of its properties with a number of turns of n =20 to 70.

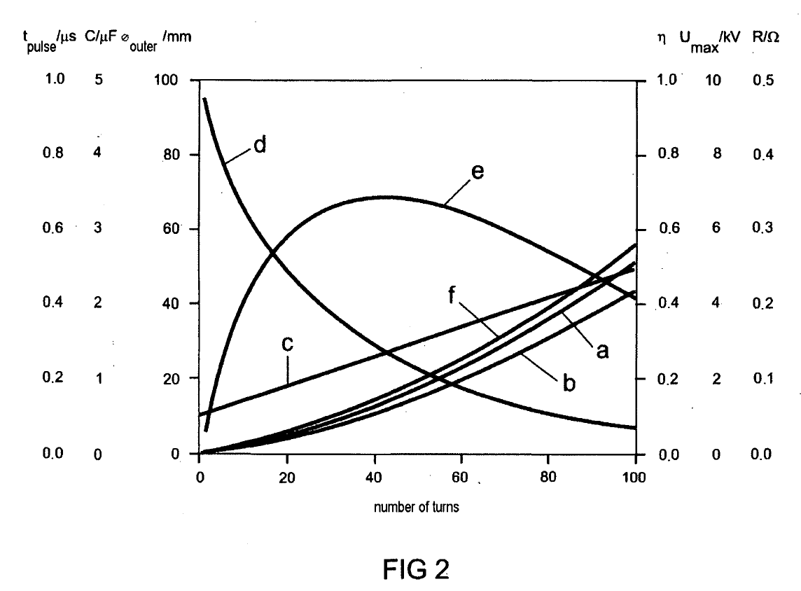

FIG. 2 illustrates the associated full width at half maximum of the high-voltage pulse in μs (curve a), the total capacitance of the component in μF (curve b), the resultant outer diameter in mm (curve c), as well as the efficiency (curve d), the maximum pulse voltage (curve e) in kV and the conductor resistance in Ω (curve f).

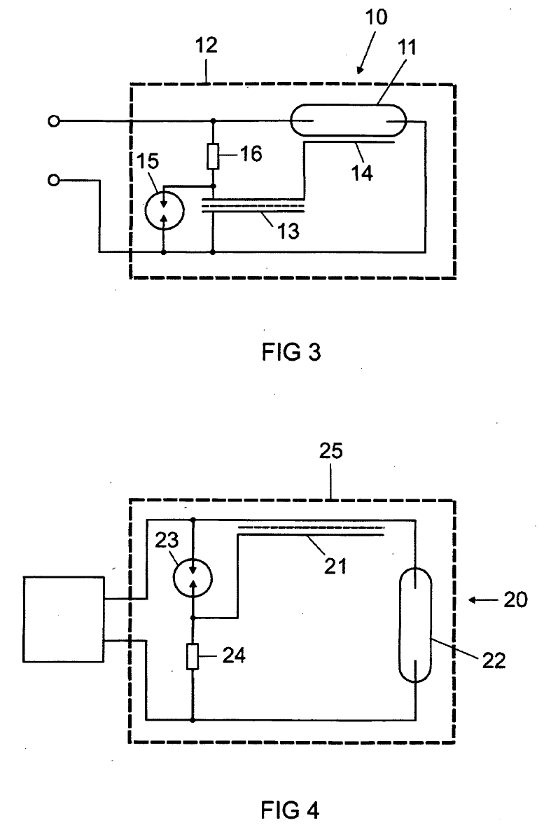

FIG. 3 shows the basic construction of a sodium high-pressure lamp 10 with a ceramic discharge vessel 11 and an outer bulb 12 with a spiral pulse generator 13 integrated therein, a starting electrode 14 being fitted on the outside of the ceramic discharge vessel 11. The spiral pulse generator 13 is accommodated with the spark gap 15 and the charging resistor 16 in the outer bulb.

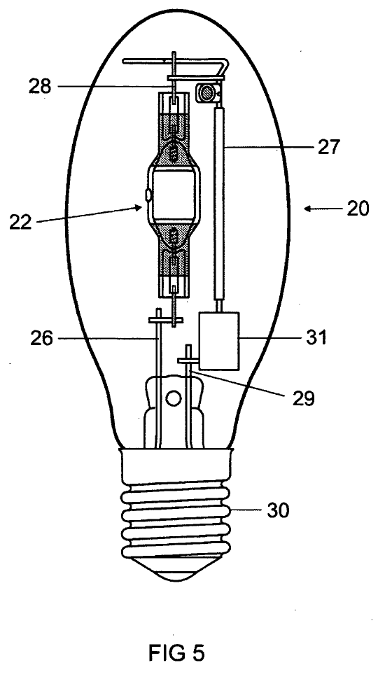

FIG. 4 shows the basic construction of a metal-halide lamp 20 with an integrated spiral pulse generator 21, without a starting electrode being fitted on the outside of the discharge vessel 22, which may be produced from quartz glass or ceramic. The spiral pulse generator 21 is accommodated with the spark gap 23 and the charging resistor 24 in the outer bulb 25.

FIG. 5 shows a metal-halide lamp 20 with a discharge vessel 22, which is held in an outer bulb by two supply lines 26, 27. The first supply line 26 is a wire with a short section bent back. The second supply line 27 is substantially a bar, which leads to the leadthrough 28 remote from the base. A starting unit 31, which includes the spiral pulse generator, the spark gap and the charging resistor, is arranged between the supply line 29 out of the base 30 and the bar 27, as indicated in FIG. 4.

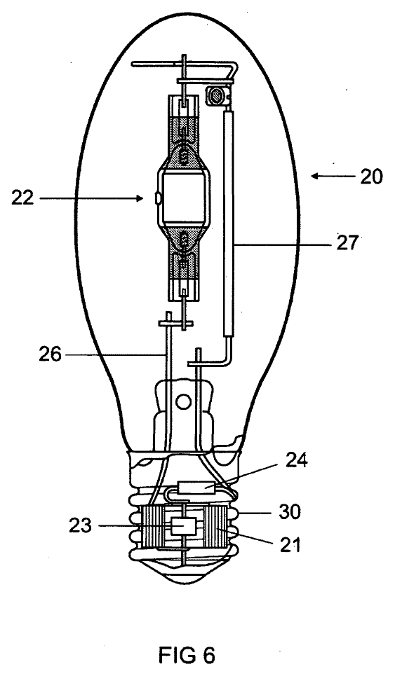

FIG. 6 shows a metal-halide lamp 20 similar to that in FIG. 5 with a discharge vessel 22, which is held in an outer bulb 25 by two supply lines 26, 27. The first supply line 26 is a wire with a short section bent back. The second supply line 27 is substantially a bar, which leads to the leadthrough 28 remote from the base. In this case, the starting unit, to be precise not only the spiral pulse generator 21 but also the spark gap 23 and the charging resistor 24, is arranged in the base 30.

This technique can also be used for lamps without electrodes, it being possible for the spiral pulse generator to act as a starting aid.

Further applications of this compact high-voltage pulse generator involve the starting of other devices. The application is primarily advantageous in the case of so-called magic spheres, the generation of X-ray pulses and the generation of electron beam pulses. Use in motor vehicles as a replacement for the customary ignition coils is also possible.

In this case, numbers of turns of n up to 500 are used, with the result that the output voltage is up to the order of magnitude of 100 kV. This is so because the output voltage U_{A}, as a function of the charging voltage U_{L}, is given by U_{A}=2×n×U_{L}×η, where the efficiency η is given by η=(OD-ID)/OD.

The invention yields particular advantages in conjunction with high-pressure discharge lamps for automobile headlamps which are filled with xenon under a high pressure of preferably at least 3 bar and metal halides. These are particularly difficult to start, since the starting voltage is more than 10 kV as a result of the high xenon pressure. Attempts are being made at present to accommodate the components of the starting unit in the base. A spiral pulse generator with an integrated charging resistor can be accommodated either in the base of the motor vehicle lamp or in an outer bulb of the lamp.

The invention yields quite particular advantages in conjunction with high-pressure discharge lamps that do not contain any mercury. Such lamps are particularly desirable for reasons of environmental protection. They contain a suitable metal halide filling and, in particular, a noble gas such as xenon under high pressure. As a result of the absence of mercury, the starting voltage is particularly high. It is typically over 20 kV. Attempts are being made at present to accommodate the components of the starting unit in the base. A spiral pulse generator with an integrated charging resistor can be accommodated either in the base of the mercury-free lamp or in an outer bulb of the lamp.

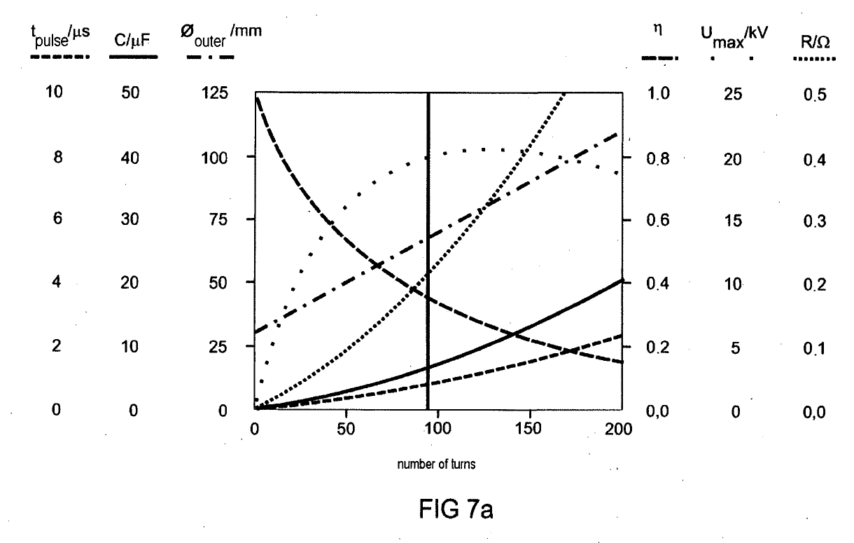

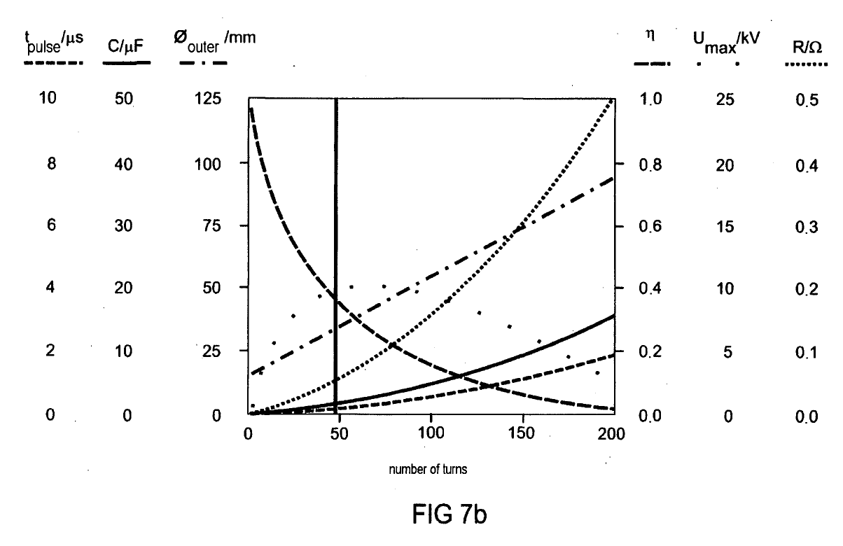

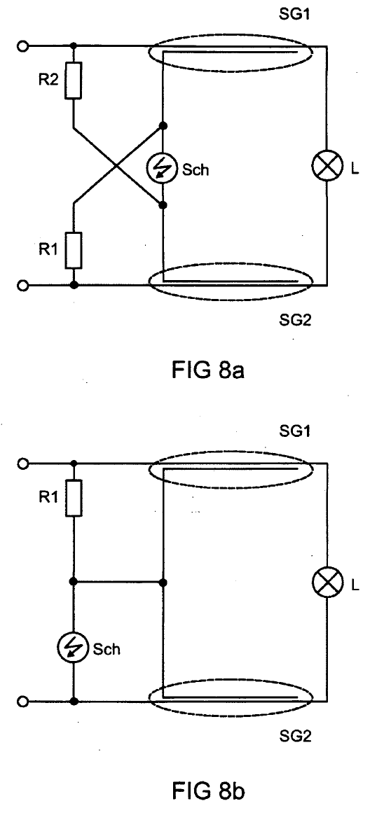

The spiral pulse generator for generating the high-voltage of, for example, 20 kV preferably has in this case two integrated generators in a single LTCC spiral or some other highly heat-resistant material. Since a single generator that is intended to generate a high-voltage pulse of, for example, 20 kV would have to have a greater outer diameter than the outer diameter of the outer bulb of the lamp (see FIG. 7a, in which various characteristics are represented in a way similar to in FIG. 2), two generators are used in push-pull circuit. This principle is known in essence from U.S. Pat. No. 4,608,521. There, however, two separate generators are used. Instead of this, it is possible in principle (FIG. 8a) to use two charging resistors R1 and R2 and a switch Sch in the form of a spark gap. The two spiral generators acting on the lamp L are designated by SG1 and SG2. FIG. 8b shows a connection that is much more effective still. In this case, only a single charging resistor R1 is used. This resistor lies in series with the switch Sch. The ends of the first spiral generator SG1 are connected to one another via the resistor R1. The ends of the other spiral generator SG2 are connected to one another via the switch. In this case, one end respectively of the two spiral pulse generators SG1 and SG2 are connected directly to one another.

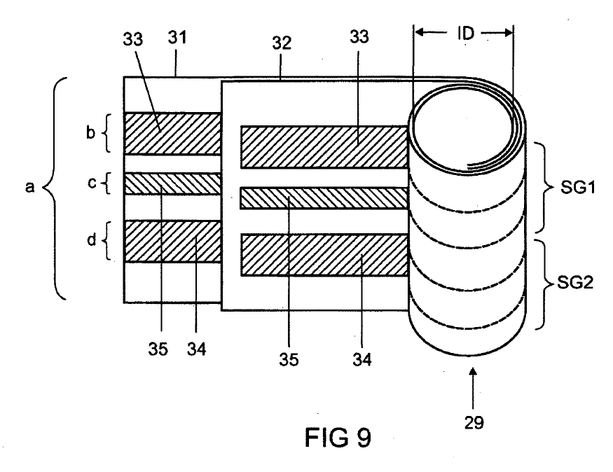

The two generators SG1 and SG2 are now configured in an integrated fashion as a single LTCC spiral 29 with two “stacked” conductor planes and perhaps with a possible shielding in between (FIG. 9). The two ceramic sheets 31 and 32 are in each case a wound-up strip and typically have a width a of from 10 to 50 mm and now at the same time include three metallic layers, which run parallel to one another. The first spiral generator SG1 is respectively formed by a first wide layer 33 (typical width b is 3 to 20 mm) of the two sheets. The second spiral generator SG2 is formed by a second, identical layer 34 with a similar width d. To be able to keep the distance between the two layers small, a shielding in the form of a narrow metallic strip 35 (typical width c is 1 to 5 mm) is perhaps applied as an option between the two layers 33 and 34.

This double ceramic sheet 31, 32 is wound up to 100 times, the inner diameter ID of the hollow cylinder produced typically being 10 to 50 mm.

Use of the LTCC technique in a double-layered configuration achieves both the effect of temperature resistance up to 600° C. and the effect of a sufficiently small outer diameter, since each individual generator only has to generate half the required high voltage, for example 10 kV (see FIG. 7b in comparison with FIG. 7a).

As a result, the characteristics change in the direction of compacting. Possible dimensionings for a single and double spiral pulse generator of an LTCC construction:

| | Single spiral pulse | | Double spiral pulse | |
|---|---|---|---|---|
| Feature | generator | | generator | |
| Turns | 95 | | 48 | |
| Inner diameter | 30 | mm | 15 | mm |
| Outer diameter | 68 | mm | 34 | mm |
| Epsilon εr | 66 | | 66 | |
| Strip width | 20 | mm | 20 | mm |
| Maximum voltage | 20 | kV | 2 × 10 kV = 20 kV | |
| Diameter, inner | 100 | mm | 15 | mm |
| Charging voltage | 400 | V | 300 | V |

In both cases, a sheet thickness of 50 μm and a conductor thickness of likewise 50 μm are used.

1. A high-pressure discharge lamp with a discharge vessel, which is accommodated in an outer bulb, a starting device which generates high-voltage pulses of at least 15 kV in the lamp being integrated in the lamp, characterized in that the starting device is accommodated in the outer bulb and comprises a first spiral pulse generator, the high starting voltage being generated by a combination of the first generator with a second such generator, the two generators being configured in an integrated fashion in a single spiral and consequently forming a double spiral pulse generator.

2. The high-pressure discharge lamp as claimed in claim 1, characterized in that the two generators are wired on the push-pull principle.

3. The high-pressure discharge lamp as claimed in claim 1, characterized in that the double spiral pulse generator is produced from a temperature-resistant material, in particular from LTCC.

4. The high-pressure discharge lamp as claimed in claim 1, characterized in that the high voltage imparted by the double spiral pulse generator acts directly on two electrodes in the discharge vessel.

5. The high-pressure discharge lamp as claimed in claim 1, characterized in that the voltage imparted by the double spiral pulse generator acts on an auxiliary starting electrode fitted on the outside of the discharge vessel.

6. The high-pressure discharge lamp as claimed in claim 1, characterized in that the double spiral pulse generator is constructed from a number of layers, the number n of layers being at least n=5.

7. The high-pressure discharge lamp as claimed in claim 6, characterized in that the number n of layers is at most n=500, preferably at most n=100.

8. The high-pressure discharge lamp as claimed in claim 1, characterized in that the spiral pulse generator has an approximately hollow-cylindrical form, in particular with an inner diameter of at least 10 mm.

9. The high-pressure discharge lamp as claimed in claim 1, characterized in that the dielectric constant ε of the spiral pulse generator is at least εᵣ=10.

10. The high-pressure discharge lamp as claimed in claim 1, characterized in that a series resistor, which limits the charging current of the spiral pulse generator, is also accommodated in the outer bulb.

11. A high-pressure discharge lamp with a discharge vessel and with an assigned starting device, the starting device generating high-voltage pulses and including a spiral pulse generator, characterized in that the spiral pulse generator is produced from an LTCC material, a high starting voltage of over 15 kV being generated in combination with a second such generator, the two generators being wired on the push-pull principle and configured in an integrated fashion in a single spiral.

12. The high-pressure discharge lamp as claimed in claim 11, characterized in that the spiral pulse generator is accommodated in an outer bulb of the lamp.

13. A compact high-voltage pulse generator based on a spiral pulse generator, characterized in that the spiral pulse generator is configured as an LTCC component and comprises two ceramic sheets and metallic conductive paste applied thereto, a high starting voltage of over 15 kV being generated by combination with a second such generator, the two generators being wired on the push-pull principle and configured in an integrated fashion in a single spiral, by two spaced-apart strips of metallic conductive paste being respectively applied to a sheet.

14. The high-voltage pulse generator as claimed in claim 13, characterized in that the spiral comprises at least n=5 turns and preferably at most n=500 turns.

15. The high-voltage pulse generator as claimed in claim 13, characterized in that a shielding is provided between the two strips.

16. A starting unit based on a high-voltage pulse generator as claimed in claim 13, characterized in that it also comprises at least one charging resistor and a switch.
